(19) United States
(12) Patent Application Publication
(10) Pub. No.: US 2006/0242657 A1
(43) Pub. Date: Oct. 26, 2006

(54) Optical drive and ejecting method thereof

(75) Inventors: Keng-Hao Kuo, Taipei City (TW); Wei-Tse Hsu, Taipei City (TW); Yung-Chih Hsu, Taipei County (TW); Yen-Ying Lai, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/405,561

(22) Filed: Apr. 18, 2006

(30) Foreign Application Priority Data
Apr. 20, 2005 (TW) 94112544

(51) Int. Cl. G11B 17/04

(52) U.S. Cl. 720/607

(57) ABSTRACT

An optical drive. The optical drive comprises a tray, a tray transmission mechanism joined with and moving the tray, a first gear, and a transmission element selectively joined with or released from the tray transmission mechanism and the first gear simultaneously. When the transmission element joins the tray transmission mechanism and the first gear simultaneously, rotating the first gear manually drives the transmission element and the tray transmission mechanism so as to move the tray.

### BACKGROUND

The invention relates to an optical drive, and in particular to tray ejection of an optical drive under a power-off status.

Typically, two methods are employed to eject a disc from an optical drive when the power is off. One is to turn on the power again and push the eject button; the other is to insert a particular tool, such as a slender object, into the ejection hole. If the power is turned on again, it may also need to be turned off again, which takes much time and may fail under certain conditions. The slender object is not always easily available everywhere when desired.

### SUMMARY

An embodiment of an optical drive of the invention comprises a tray, a tray transmission mechanism joined with and moving the tray, a first gear, and a transmission element selectively joined with or released from the tray transmission mechanism and the first gear simultaneously. When the transmission element joins the tray transmission mechanism and the first gear simultaneously, the first gear is rotated to drive the transmission element and the tray transmission mechanism so as to move the tray.

The tray transmission mechanism comprises a second gear capable of joining the transmission element, and the tray comprises a rack engaging the second gear. The transmission element comprises a third gear.

The optical drive further comprises a first controller and a second controller. When the optical drive is transferred to a power-on status from a power-off status, the first controller has greater effect on the transmission element than the second controller so as to move the transmission element in a first direction to release the third gear from the first gear and the second gear. The first controller comprises an electromagnet, and the transmission element comprises a connector which is attracted by the electromagnet when the optical drive is under the power-on status.

When the optical drive is transferred to the power-off status from the power-on status, the second controller has greater effect on the transmission element than the first controller so as to move the transmission element in a second direction to join the third gear with the first gear and the second gear. The second controller comprises a spring joining the transmission element, and the spring pulls the transmission element in the second direction to join the third gear with the first gear and the second gear when the optical drive is under the power-off status.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of an ejecting mechanism of an optical drive under the power-on status; and

FIG. 2 is a schematic view of an embodiment of an ejecting mechanism of an optical drive under the power-off status.

### DETAILED DESCRIPTION

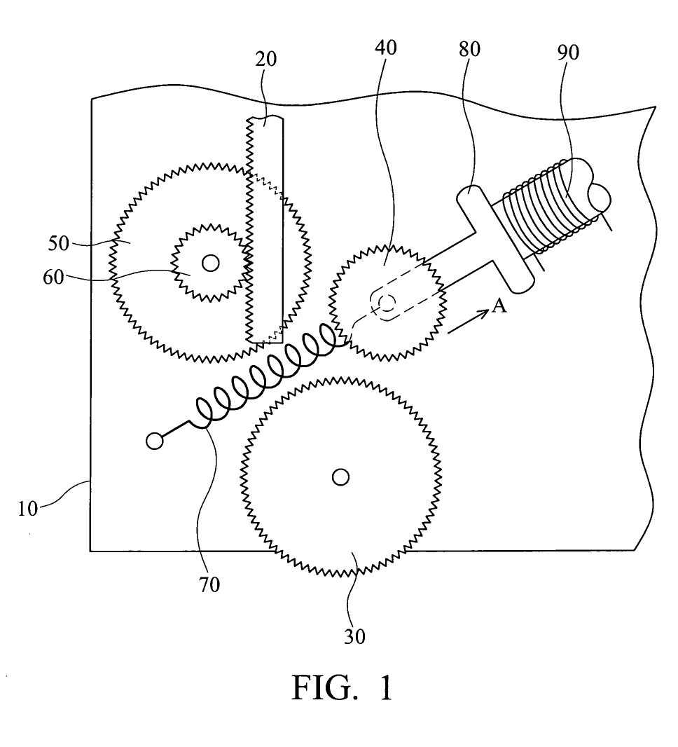

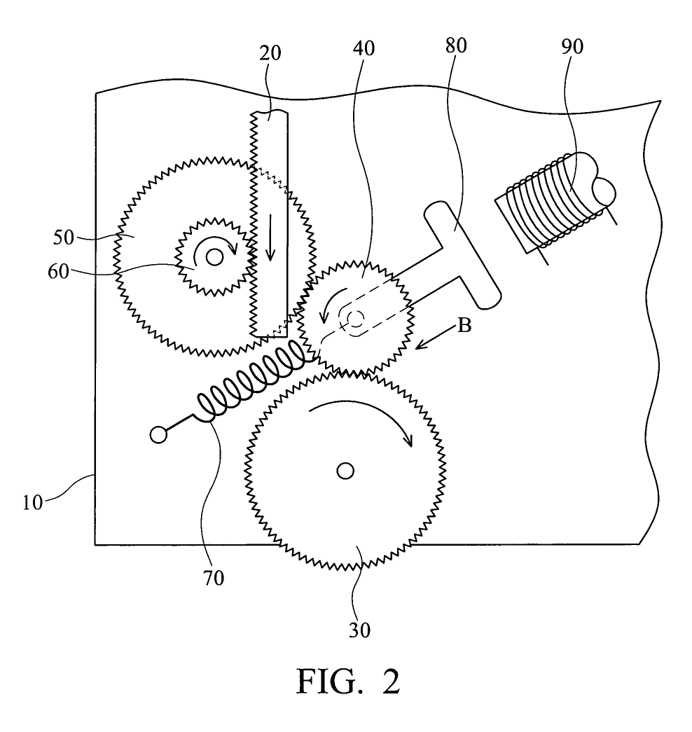

Referring to FIGS. 1 and 2, an ejection mechanism of an optical drive 10 comprises a rack 20 connected to a tray (not shown), a first gear 30, a transmission element including a third gear 40, a tray transmission mechanism (second gears 50 and 60), a first controller 90 such as an electromagnet in this embodiment, and a second controller 70 such as a spring. Second gears 50 and 60 are concentrically disposed near the first gear 30, and the diameter of the gear 60 is smaller than that of the gear 50. The gears 50 and 60 rotate to drive the rack 20 which engages the second gear 60 to move the tray.

The third gear 40 is connected to a connector 80. The electromagnet 90 is disposed opposite to the connector 80. As FIG. 1 shows, when current passes through the electromagnet 90 (i.e. the optical drive is under the power-on status), a magnetic force is caused to attract the connector 80 and move the third gear 40 in a first direction A. One end of the spring 70 is connected to the axis of the third gear 40, the other end thereof is fixed to the chassis of the optical drive 10. The spring 70 can pull the third gear 40 in a second direction B opposite to the magnetic force of the electromagnet 90. As FIG. 2 shows, when no current passes through the electromagnet 90 (i.e. the optical drive is under the power-off status), the magnetic force is no longer present and the spring 70 pulls the third gear 40 in the second direction B opposite to the first direction A to join with the second gear 50 and the first gear 30 simultaneously.

In FIG. 1, when power is provided for the optical drive 10, the first controller has greater effect than the second controller. That is, the electromagnet 90 provides a magnetic force which is stronger than the spring force to attract the connector 80 and the third gear 40, thereby releasing the third gear 40 from the second gear 50 and the first gear 30.

In FIG. 2, when power for the optical drive 10 is turned off, no magnetic force is provided, and the third gear 40 is pulled by the spring 40 to join with the second gear 50 and the first gear 30. The first gear 30 is capable of being rotated without limit to drive the third gear 40 so as to rotate the second gear 50 ejecting the tray via the second gear 60.

Though two second gears 50 and 60 are shown in this embodiment, people skilled in this art would understand that one second gear engaged with the rack 20 and selectively engaged with the third gear 40 at different sides is sufficient to accomplish the purpose of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical drive, comprising:
a tray;
a tray transmission mechanism joined with and moving the tray;
a first gear; and
a transmission element selectively joined with or released from the tray transmission mechanism and the first gear simultaneously, wherein when the transmission element joins the tray transmission mechanism and the first gear simultaneously, the first gear is rotated to drive the transmission element and the tray transmission mechanism so as to move the tray.

2. The optical drive as claimed in claim 1, wherein the tray transmission mechanism comprises a second gear capable of joining the transmission element, and the tray comprises a rack engaging the second gear.

3. The optical drive as claimed in claim 2, wherein the transmission element comprises a third gear.

4. The optical drive as claimed in claim 3 further comprising a first controller and a second controller, wherein when the optical drive is transferred to a power-on status from a power-off status, the first controller has greater effect on the transmission element than the second controller so as to move the transmission element in a first direction to release the third gear from the first gear and the second gear.

5. The optical drive as claimed in claim 4, wherein the first controller comprises an electromagnet, and the transmission element comprises a connector which is attracted by the electromagnet when the optical drive is under the power-on status.

6. The optical drive as claimed in claim 4, wherein when the optical drive is transferred to the power-off status from the power-on status, the second controller has greater effect on the transmission element than the first controller so as to move the transmission element in a second direction to join the third gear with the first gear and the second gear.

7. The optical drive as claimed in claim 6, wherein the second controller comprises a spring joining the transmission element, and the spring pulls the transmission element in the second direction to join the third gear with the first gear and the second gear when the optical drive is under the power-off status.

8. The optical drive as claimed in claim 7, wherein the second direction is opposite to the first direction.

9. The optical drive as claimed in claim 1, wherein the first gear is capable of rotating without limit.

10. An ejecting method for an optical drive including a tray, a tray transmission mechanism joined with and moving the tray and a first gear, said method comprising the following steps:
providing a transmission element joined with or released from the tray transmission mechanism and the first gear simultaneously under a power-off status or a power-on status respectively; and
rotating the first gear to drive the transmission element and the tray transmission mechanism so as to move the tray when the transmission element joins the tray transmission mechanism and the first gear simultaneously.

11. The ejecting method as claimed in claim 10 further comprising the following steps:
providing a first controller which attracts the transmission element to release from the tray transmission mechanism and the first gear under the power-on status;
providing a second controller which pulls the transmission element to join the tray transmission mechanism and the first gear; and
cutting off the power.

12. The ejecting method as claimed in claim 11, wherein the first controller comprises an electromagnet, the transmission element comprises a connector which is attracted by the electromagnet, and the second controller comprises a spring joining the transmission element.

13. The ejecting method as claimed in claim 12, wherein the tray transmission mechanism comprises a second gear, the tray comprises a rack engaging the second gear, and the transmission element comprises a third gear capable of joining the first gear and the second gear.
